(19) United States
(12) Patent Application Publication
(10) Pub. No.: US 2006/0068363 A1
(43) Pub. Date: Mar. 30, 2006

(54) Coated dental implants

(75) Inventor: Roman Denk, Weidenstetten (DE)

Correspondence Address: FLASTER/GREENBERG P.C., 1810 CHAPEL AVENUE WEST, CHERRY HILL, NJ, 08002, US

(73) Assignee: Polyzenix GmbH

(21) Appl. No.: 11/234,988

(22) Filed: Sep. 26, 2005

Related U.S. Application Data
(63) Continuation of application No. PCT/EP04/03262, filed on Mar. 26, 2004.
(60) Provisional application No. 60/457,694, filed on Mar. 26, 2003.

(51) Int. Cl. A61C 8/00

(52) U.S. Cl. 433/201.1

(57) ABSTRACT

The present invention relates to coated dental implants which allow a sufficient take of the gingiva onto said dental implants, thereby preventing inter alia gingival sulcus and bacterial infections of the gingiva and methods of using said coated dental implants for preventing the formation of gingival sulcus and bacterial infection upon their implantation into a patient.

This application is a continuation of copending Application No. PCT/EP2004/003262, filed Mar. 26, 2004, entitled “Coated Dental Implants,” which was published on Oct. 7, 2004 under Publication No. WO 04/084966 A1 in the English language, and further claims the benefit under 35 U.S.C. § 119(e) of U.S. Provisional Application No. 60/457,694, filed Mar. 26, 2003, entitled “Coated Dental Implants”, the entire disclosures of which are incorporated herein by reference

This application is a continuation of copending Application No. PCT/EP2004/003262, filed Mar. 26, 2004, entitled “Coated Dental Implants,” which was published on Oct. 7, 2004 under Publication No. WO 04/084966 A1 in the English language, and further claims the benefit under 35 U.S.C. § 119(e) of U.S. Provisional Application No. 60/457,694, filed Mar. 26, 2003, entitled “Coated Dental Implants”, the entire disclosures of which are incorporated herein by reference.

### FIELD OF THE INVENTION

The present invention relates to coated dental implants which allow a sufficient take of the gingiva onto said dental implants, thereby preventing inter alia gingival sulcus and bacterial infections of the gingiva and methods of using said coated dental implants for preventing the formation of gingival sulcus and bacterial infection upon their implantation into a patient.

### BACKGROUND OF THE INVENTION

One of the most serious complications known from artificial implants is an increased deposition of thrombocytes at the surface of implants in a patient. A possibility to deal with this complication is to use coated implants. For example, DE 196 13 048 describes artificial implants having a biocompatible coating which contains a compound with antithrombogenic properties.

A frequent problem of artificial dental implants lies in an insufficient connection between the gingiva and the dental implant; i.e. an insufficient tissue integration of the dental implant onto the gingiva upon implantation into a patient. An insufficient connection often results in the formation of gingival sulcus and an increased risk of bacterial infections. This can lead, in the worst case, to severe inflammation in connection with a loss of the dental implant.

At present, no promising solution for a sufficient take of the gingiva onto dental implants without or at least reduced formation of gingival sulcus and/or without or at least reduced risk of bacterial infections are known in the art.

### BRIEF SUMMARY OF THE INVENTION

It is an object of the present invention to provide an artificial dental implant which allows a sufficient take of the gingiva onto the dental implant, thereby preventing substantially the formation of gingival sulcus, at least minimizing the risk of bacterial infections and improving the long-term tolerance of the dental implant, upon its implantation into a patient.

In particular, the present invention relates to a dental implant comprising a dental implant material having a biocompatible coating which is applied to at least a part of the surface of the implant material, wherein the biocompatible coating allows a sufficient take of the gingiva onto the dental implant resulting in (i) substantially no formation of gingival sulcus, (ii) substantially no bacterial infections of the gingiva close to the coated dental implant and (iii) an improved long-term tolerance of the coated dental implant.

The expression “at least part of the surface” means that part of the surface of the implant material, which should come into contact with the gingiva of the patient upon implantation.

It is another object of the present invention to provide methods of (i) preventing the formation of gingival sulcus at a dental implant, (ii) preventing bacterial infections of the gingiva at a dental implant and (iii) taking the gingiva onto a dental implant, upon implantation of the dental implant of the present application into a patient.

### DETAILED DESCRIPTION OF THE INVENTION

In a preferred embodiment of the present invention, the dental implant comprises an implant material having a biocompatible coating which is applied to at least a part of the surface of implant material, wherein said biocompatible coating contains a polymer having the general formula (I) 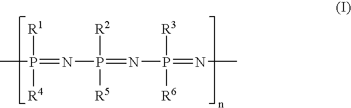
wherein n is from 2 to ∞

R¹ to R⁶ are the same or different and represent an alkoxy, alkylsulfonyl, dialkylamino or aryloxy group, or a heterocycloalkyl or heteroaryl group having nitrogen as the heteroatom.

In the polymer of formula (I) it is preferred that at least one of the groups R¹ and R² is an alkoxy group substituted with at least one fluorine atom.

In the polymer of formula (I), the alkyl groups in the alkoxy, alkylsulfonyl and dialkylamino groups are, for example, straight-chain or branched-chain alkyl groups having 1 to 20 carbon atoms, wherein the alkyl groups can be substituted, for example, with at least one halogen atom, such as a fluorine atom.

Examples of alkoxy groups are methoxy, ethoxy, propoxy and butoxy groups, which preferably can be substituted with at least one fluorine atom. The 2,2,2-trifluoroethoxy group is particularly preferred.

Examples of alkylsulfonyl groups are methylsulfonyl, ethylsulfonyl, propylsulfonyl and butylsulfonyl groups.

Examples of dialkylamino groups are dimethylamino, diethylamino, dipropylamino and dibutylamino groups.

The aryl group in the aryloxy group is, for instance, a compound having one or more aromatic ring systems, wherein the aryl group can be substituted, for instance, with at least one alkyl group as defined above.

Examples of aryloxy groups are phenoxy and naphthoxy groups, and derivatives thereof.

The heterocycloalkyl group is, for example, a ring system containing 3 to 7 atoms, at least one of the ring atoms being a nitrogen atom. The heterocycloalkyl group can, for example, be substituted with at least one alkyl group as defined above. Examples of heterocycloalkyl groups are piperidinyl, piperazinyl, pyrrolidinyl and morpholinyl groups, and derivatives thereof.

The heteroaryl group is, for example, a compound with one or more aromatic ring systems, wherein at least one ring atom is a nitrogen atom. The heteroaryl group can, for example, be substituted with at least one alkyl group as defined above. Examples of heteroaryl groups are pyrrolyl, pyridinyl, pyridinolyl, isoquinolinyl and quinolinyl groups, and derivatives thereof.

In a preferred embodiment of the present invention, the biocompatible coating contains the polymer bis-poly-trifluorethoxy-polyphosphazene.

The production of polymers of formula (I), such as bis-poly-trifluorethoxy-polyphosphazene, starting with hexachlorocyclotriphosphazene, is known in the art. The polymerization of hexachlorocyclotriphosphazene is extensively described in Korsak et al., Acta Polymerica 30, No. 5, pages 245-248 (1979). Esterification of the polydichlorophosphazene produced by the polymerization is described in Fear, Thower and Veitch, J. Chem. Soc., page 1324 (1958).

The biocompatible coating of the dental implant according to the present invention has, for example, a thickness from about 1 nm to about 100 μm, preferably from about 10 nm to about 10 μm, and more preferably up to about 1 μm.

There is no particular limitation of the material to be used for the uncoated dental implant. It can be any implant material useful for dental implants. In particular, the dental implant material can be a metal, an alloy, a polymeric material or a ceramic material. For example, the metallic material can be titanium. In a preferred embodiment of the present invention, the titanium is electropolished to obtain a TiO₂ surface of the uncoated dental implant.

In one embodiment of the present invention, a layer containing an adhesion promoter is provided between the surface of the uncoated dental implant and the biocompatible coating. The adhesion promoter, or spacer, is, for example, an organosilicon compound, preferably an amino-terminated silane or a compound based on an aminosilane, or an alkylphosphonic acid. Aminopropyl trimethoxysilane is especially preferred.

The adhesion promoter particularly improves the adhesion of the biocompatible coating to the surface of the dental implant material through coupling of the adhesion promoter to the surface of the dental implant material, by, for instance, ionic and/or covalent bonds, and through further coupling of the adhesion promoter to reactive components, particularly to the polymer of the biocompatible coating, by, for instance, ionic and/or covalent bonds.

The surprisingly improved take of the gingiva onto the dental implant of the present invention may be based on, but not limited, to a mechanism that the biocompatible coating of the dental implant according to the invention adsorbs reversible native proteins without denaturation, resulting in an imitation of a biological and physiological surface. This unique property of the dental implant of the present invention allows an improved and accelerated take of the gingiva onto the dental implant without the formation of gingival sulcus. Moreover, bacterial infections of the gingiva can be prevented at the dental implant of the present invention upon its implantation into a patient, and the long-term tolerance of the dental implant of the present invention can be improved.

The present invention will now be further illustrated in the following examples, without being limited thereto.

### EXAMPLE 1

Cell Testings:

Coated and non-coated titanium plates were tested concerning their biocompatibility.

The test was performed with HEKn-Keratinozytes with a density of 30000 cells/cm² on different coated and non-coated titanium plates. The incubation of the cells was performed in EpiLife—medium at 37° C. at 5% CO₂ atmosphere in an incubator. The proliferation of new cells was measured by marking novell generated cells during the trial phase with bromodeoxyuridine and comparing the intensity via antibody reaction generated colour in an Elisa-Reader at 620 nm.

Results:

The Polyzene-F coated titanium plates showed after 24 h a significantly higher number of newly generated cells than found on the bare titanium. Ti=100% versus Ti-Polyzene-F=150%.

### EXAMPLE 2

Fifteen conventional dental implants (commercially available from Dr. Ihde Dental GmbH, Munich, Allfit® STI, Size 4.1 mm diameter, length 111 and 13 mm, respectively) made from pure titanium were electropolished (commercially available from Admedes Schüβler GmbH, Pforzheim). This procedure provides a pure TiO₂ surface. Highly purified linear Polyzene-F (bis-poly-trifluor-ethoxy-phosphazene, commercially available from Polyzenix GmbH, Ulm) having a molecular weight of more than 12 millions and a Cl-concentration of below 0.0005%, was applied to the whole surface of the dental implants. Fifteen dental implants without any coating were used as controls. Each of the dental implants were implanted into the jawbone of patients and the tissue integration of the gingiva onto the dental implants was evaluated.

Approximately 8 weeks after implantation the dental implants according to the present invention showed a complete take of the gingiva onto the dental implants and no gingival sulcus were observed. In contrast thereto, the dental implants of the control group showed no sufficient take of the gingiva onto the dental implants and clear formations of gingival sulcus with a depth of 2 mm or more, in some cases already accompanied by bacterial infections, were observed in said patients.

The dental implants according to the present invention improve drastically the take of the gingiva onto the dental implants upon implantation into a patient. This surprising result prevents the formation of gingival sulcus, and thereby the risk of bacterial infections can be minimized, if not prevented. As a consequence, the sufficient take of the gingiva onto the dental implants of the present invention substantially reduces or prevents the loss of the dental implant and improves the long-term tolerance of the dental implant.

1-4. (canceled)

5. A method of preventing the formation of gingival sulcus at a dental implant upon implantation into a patient, comprising implanting a dental implant comprising an implant material having a biocompatible coating, wherein the coating is applied to at least a part of a surface of the implant material.

6. The method according to claim 5, wherein the biocompatible coating contains a polymer having the general formula (I) 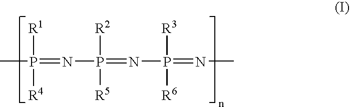
wherein R¹ to R⁶ are the same or different and represent an alkoxy, alkylsulfonyl, dialkylamino or aryloxy group, or a heterocycloalkyl or heteroaryl group having nitrogen as the heteroatom.

7. The method according to claim 6, wherein at least one of the groups R¹ and R² is an alkoxy group substituted with at least one fluorine group.

8. The method according to claim 5, wherein the biocompatible coating contains a bis-poly-trifluorethoxy-polyphosphazene.

9-12. (canceled)

13. A method of improving the take of the gingiva onto a dental implant upon implantation into a patient, comprising implanting a dental implant which comprises an implant material having a biocompatible coating, wherein the coating is applied to at least a part of a surface of the implant material.

14. The method according to claim 13, wherein the biocompatible coating contains a polymer having the general formula (I) 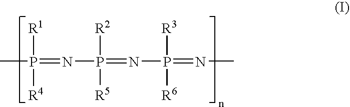
wherein R¹ to R⁶ are the same or different and represent an alkoxy, alkylsulfonyl, dialkylamino or aryloxy group, or a heterocycloalkyl or heteroaryl group having nitrogen as the heteroatom.

15. The method according to claim 14, wherein at least one of the groups R¹ and R² is an alkoxy group substituted with at least one fluorine group.

16. The method according to claim 13, wherein the biocompatible coating contains a bis-poly-trifluorethoxy-polyphosphazene.
